(19) United States
(12) Patent Application Publication
(10) Pub. No.: US 2020/0302332 A1
(43) Pub. Date: Sep. 24, 2020

(54) CLIENT-SPECIFIC DOCUMENT QUALITY MODEL

(71) Applicant: INTERNATIONAL BUSINESS MACHINES CORPORATION, Armonk, NY (US)

(72) Inventors: David Contreras, Willow Spring, NC (US); Krishna Mahajan, Raleigh, NC (US); Roberto Delima, Apex, NC (US); Andrew R. Freed, Cary, NC (US); Brien Muschett, Palm Beach Gardens, FL (US)

(21) Appl. No.: 16/359,591

(22) Filed: Mar. 20, 2019

(51) Int. Cl. G06N 20/00; G06N 5/00

(52) U.S. Cl. CPC G06N 20/00; G06N 5/003

(57) ABSTRACT

A computer-implemented method, system and computer program product for generating a client-specific document quality model, by: analyzing data using existing quality heuristics to identify new, unexpected or problem patterns in the data; forming the quality heuristics into one or more clusters for each container level of the data; exploring each of the clusters to identify sources of the patterns; and developing new quality heuristics based on the sources of the patterns, wherein the new quality heuristics are used to generate the client-specific document quality model.

### BACKGROUND

Artificial intelligence (AI) techniques, including sophisticated techniques such as machine learning (ML), can be applied to documents and other textual data to enhance analysis of the data. Machine learning is defined broadly as computer-implemented methods and systems for simulating intelligence by using data to tune algorithms.

Machine learning may be used for natural language processing (NLP), which focuses on how to process large amounts of natural language data. Natural language understanding (NLU) is a sub-topic of natural language processing that focuses primarily on machine reading comprehension. Natural language understanding often is directed to syntax (understanding the grammar of the text), semantics (understanding the meaning of the text) and pragmatics (understanding what the text is trying to achieve).

However, problems may arise due to variability in documents and other text data. Specifically, the quality of documents and other text data can vary widely, which greatly impacts natural language processing and natural language understanding.

Thus, there is a need in the art for improved systems and methods for addressing the variability of documents and other text data. The present invention satisfies this need.

### SUMMARY

The invention provided herein has a number of embodiments useful, for example, in a computer-implemented method, system and computer program product, for generating a client-specific document quality model, by: analyzing an initial set of data using existing quality heuristics to identify new, unexpected or problem patterns in the data; forming the quality heuristics into one or more clusters for each container level of the data; exploring each of the clusters to identify sources of the patterns; and developing new quality heuristics based on the sources of the patterns, wherein the new quality heuristics are used to generate the client-specific document quality model.

### DRAWINGS

Referring now to the drawings in which like reference numbers represent corresponding parts throughout:

FIG. 1 illustrates an exemplary system for generating client-specific document quality models according to an embodiment of the present invention.

FIG. 2 illustrates an exemplary method for generating client-specific document quality models according to an embodiment of the present invention.

FIG. 3 depicts a cloud computing environment according to an embodiment of the present invention.

FIG. 4 depicts abstraction model layers according to an embodiment of the present invention.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

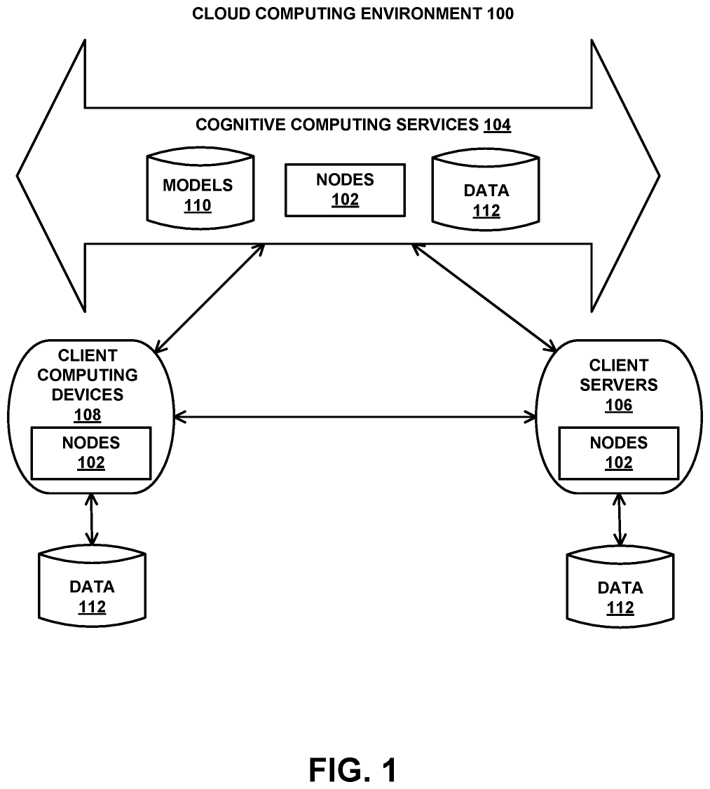

FIG. 1 illustrates an exemplary system according to an embodiment of the present invention. A cloud computing environment 100 comprised of one or more nodes 102 is used, wherein the nodes 102 implement cognitive computing services 104, one or more client servers 106, and one or more client computing devices 108 operated by end-users. The cognitive computing services 104 apply machine learning to generate one or more client-specific document quality models 110, which are machine learning models 110, using client-specific data 112, such as documents or text data 112, received from the client servers 106 or client computing devices 108.

Cognitive Computing Services

In the present invention, the cognitive computing services 104 provide both natural language processing and natural language understanding using the machine learning models 110. In one embodiment, the cognitive computing services 104 are implemented using the Watson® Natural Language Understanding services offered by IBM Corporation, the assignee of the present invention. However, other machine learning could also be used.

The Watson® Natural Language Understanding services extract and analyze metadata from documents or other textual data 112, including entities, relations, concepts, sentiment, and emotion, using the machine learning models 110. Specifically, the Watson® services provide an infrastructure for performing an analysis of the data 112 using the machine learning models 110, in order to recognize patterns in the data 112.

The services provided by the Watson® services include:
Repository service—Stores the models 110 that are created so that they can be retrieved to create deployments.
Deployment service—Deploys models 110 so that they can be used for predictions.
Scoring service—Uses the deployed models 110 for analyzing the data 112 to identify patterns found in the data 112.

The Watson® services also provide application programming interfaces (APIs) that enable applications to search, explore, and administer collections of machine learning models 110. These APIs allow applications to use hypertext transport protocol (HTTP) requests to post data 112 (create and update), read data 112 (such as running queries), delete data 112, and return data 112 (responses to queries). Alternative mechanisms may be used as well.

In the present invention, one or more machine learning models 110 derived by the cognitive computing services 104 are used for formulation of any useful insights on the quality of the client-specific data 112, which may comprise healthcare data, such as electronic medical records (EMR). For example, an initial set of data 112 is imported into the cognitive computing services 104 from the client servers 106 or the client computing devices 108, wherein the initial set of data 112 is used by the cognitive computing services 104 to train the machine learning models 110. A subsequent set of data 112 is imported into the cognitive computing services 104 from the client servers 106 or the client computing devices 108, wherein the cognitive computing services 104 use the machine learning models 110 to analyze the data 112 and generate responses thereto, which are returned by the cognitive computing services 104 to the client servers 106 or the client computing devices 108.

However, when analyzing a new client's data 112, the natural language processing and the natural language understanding may be performed in a manner that may not be specific to the data 112, because different clients have different ways of writing or formatting their data 112. For data 112 from new clients, there may be new, unexpected or problem patterns in the data 112 for which the natural language processing and the natural language understanding need to be adapted.

Initially, this may result in the natural language processing and the natural language understanding detecting false positives or false negatives and thus diminishing the new client's confidence in the outcome. On investigation, existing document quality heuristics may inform that the overall quality score is low for the new client's data 112 and the natural language processing and the natural language understanding may not perform as designed. In the prior art, there is no architecture to customize the natural language processing and the natural language understanding to adapt these specific issues.

The present invention, on the other hand, generates a client-specific document quality model 110, by: analyzing data 112, which is comprised of documents or text, using existing quality heuristics to identify new, unexpected or problem patterns in the data 112; forming the quality heuristics into one or more clusters for each container level of the data 112, wherein the container level comprises document, section, paragraph or sentence, and the quality heuristics are formed into clusters comprises using unsupervised machine learning models; exploring the clusters to identify sources of the patterns, wherein the patterns comprise an issue of integration or an issue that is client-specific; and developing new quality heuristics based on the sources of the patterns, wherein the new quality heuristics are used to generate the client-specific document quality model 110, and to analyze additional data 112.

### EXAMPLES

Following are some examples of documents and other textual data 112 with different issues that can be addressed using the present invention.

Narrative Example:
Mrs. is a 53-year-old female who recently presented to her physician with a concern for an incarcerated femoral hernia. She was referred to the general surgeons who agreed with that diagnosis and on Nov. 15, 2011, performed what they intended to be a groin exploration with hernia repair; however, upon opening the groin they found a mass consistent with cancerous lymph nodes. They did remove this mass en bloc, and it was found to contain metastatic squamous cell carcinoma. At this point, there was no known primary. She did undergo a gynecologic exam with examination of the cervix as well as an ultrasound of her ovaries.

List Item Example:
Synoptic Report
   Specimen: Liver, gallbladder.
      Procedure: Partial hepatectomy.
      Tumor Size: Range from 0.7 to 8.5 cm in greatest extent.
      Tumor Focality: Multifocal: right lobe.
      Histologic Type: Hepatocellular carcinoma.
      Histologic Grade: G2.
      Tumor Extension: Tumor confined to liver.
      Surgical Margins: Not applicable
      Lymphovascular Invasion: Macroscopic Venous (large vessel) Invasion:
      Not identified. Microscopic (small vessel) Invasion: Present.
      Pathologic Staging (AJCC, 7th edition):
      Primary tumor: pT3a
      Regional lymph nodes: pNX
         Number examined (total): 0
         Number involved (total): 0
   Distant Metastasis: Not applicable.
   Additional Findings: Large cell dysplastic nodule. Non-neoplastic liver shows bile ductular reactions, mild chronic inflammation and rare lipogranulomas. No significant steatosis seen.

Sentence Summary Example:
55yoM w h/o recently diagnosed stage IV, metastatic gastric adenocarcinoma (mets to liver, LN), Her-2 negative an EGD was performed on Sep. 24, 2015 which showed one non-obstructing oozing cratered gastric ulcer in the cardia 15mm. Pathology from a cardia biopsy revealed invasive adenocarcinoma, poorly-differentiated, intestinal type.

Natural Language Processing of the Examples

Each example above contains relevant content, i.e., clinical data, that must be processed. However, the results from the natural language processing will be different for each example.

The text of the Narrative Example provides good grammar and the natural language processing will work well in this example.

The text of the List Item Example requires special handling. The text, when viewed by a human, looks like list items; however, there are no indications of list items in the text aside from bullets and indentations. Also, not every line ends with a period and sentences are very short. In this case, these issues are detected and the natural language processing can be modified to create list items when it finds multiple lines starting with a word follow by a colon (“:”), and this modification will provide a good break between sentences and attributes that need to be grouped with each other.

The text of the Sentence Summary Example is packed with information, grammatical errors and compressed information about the patient. For the most part, this will be a problem because of the length of the sentence, grammatical errors and probable incomplete parse trees. In this case, the natural language processing will need to be enhanced to detect how age and gender are compressed in a single token, and will need to assist the parse tree by creating nouns of multiple tokens or enhanced algorithms to extract information out of incomplete parses.

Process Steps

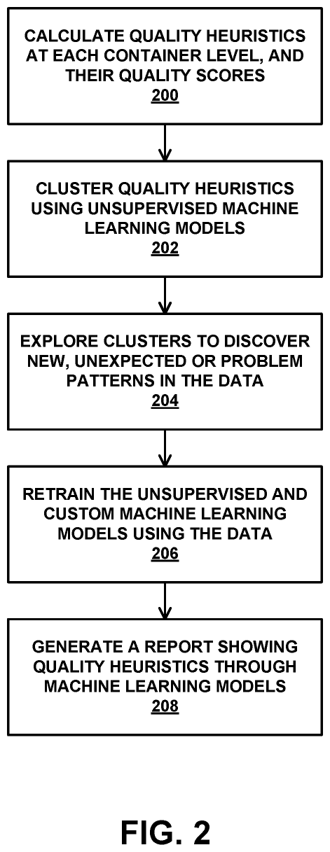

FIG. 2 illustrates an exemplary method for generating client-specific document quality models according to an embodiment of the present invention.

Block 200 represents the cognitive computing services 104 calculating an initial set of quality heuristics for data 112, namely, an initial set of data 112, at each container level, i.e., Document, Section, Paragraph and Sentence. The quality heuristics at each container level include, but are not limited to, the following:
At container level “Document”:
   Number of sections.
   Number of paragraphs.
   Number of sentences.
   Incomplete parses.
   Total number of HTML, j son tags.
   Total number of Unicode characters.
   Average size of sentences.
At container level “Section”:
   Number of paragraphs.
   Number of sentences.
   Number of HTML, j son tags.
   Number of Unicode characters.
   Average size of sentences.
   Incomplete parses.
At container level “Paragraph”:
   Number of sentences.
   Number of HTML, j son tags.
   Number of Unicode characters.
   Average size of sentences.
   Incomplete parses.
At container level “Sentence”:
   Number of HTML, j son tags.
   Number of Unicode characters.
   Incomplete parses.

This block also includes the cognitive computing services 104 calculating a quality score at each container level using the quality heuristics, and calculating an overall quality score for the data 114 from the combination of quality scores of each container level. In one embodiment, the overall quality score comprises the following:

Overall Quality Score=a(Document level quality score)+b(Section level quality score)+c(Paragraph level quality score)+d(Sentence level quality score),
where a, b, c, d are respective normalized weights of each container level in the overall quality score.

Block 202 represents the cognitive computing services 104 clustering the quality heuristics generated at each container level using unsupervised machine learning models 110:
At each container level, use the quality heuristics as features for unsupervised machine learning models 110, such as K-means, to form clusters.
Calculate the quality score of clusters formed at each container level.
Repeat the K-means clustering with different values of K until the quality scores for clusters formed at each container level are distinctly differently.

Block 204 represents the cognitive computing services 104 exploring the clusters to find new, unexpected or problem patterns in the data 112, wherein the patterns may comprise an issue of integration or an issue that is client-specific. In one embodiment, this includes the following:
(A) Performing an analysis of the clusters to identify new, unexpected or problem patterns found in the data 112:
   (i) Different clusters at each container level (Document, Section, Paragraph and Sentence) are identified.
   (ii) Segregate the different clusters at each container level based on a comparison of a quality score with a threshold, i.e., where the quality heuristics are disproportionate. For example, the following combination of quality heuristics may be used to validate that the cluster's quality score is below the threshold:
   At container level “Document”:
      Length of document either very large or very small.
      Too many or too few numbers of sections.
      Too many HTML tags or unexpected characters in the document.
   At container level “Section”:
      Too many or too few numbers of paragraphs.
   At container level “Paragraph”:
      Too many or too few numbers of sentences.
   At container level “Sentence”
      Too large or too small lengths of sentences.
      Too many grammatically incorrect sentences.
      Too few existing annotations (i.e., relevant content).
      Too many HTML tags or unexpected characters.
   (iii) Retrieve the data 112 (e.g., actual text) corresponding to these clusters.
   (iv) Review the retrieved data 112 to further ratify the comparison of the quality scores with the threshold, i.e., the new, unexpected or problem patterns comprise either an issue of integration or an issue that is client-specific. For example, clusters with quality scores below a threshold due to an integration issue may have the following quality heuristics:
   High density of number of sentences with incorrect grammatical structure.
   High density of HTML tags or unexpected characters at the document level as well as the sentence level.
   Extreme variations in sentence length.
   (v) Clusters with quality scores below the threshold without the above quality heuristics may be classified as due to a client-specific issue, rather than an integration issue. These new, unexpected or problem patterns in the data 112 should be easy to recognize through probing, such as a distinctive way of writing headers, list items, paragraph openings, surgery reports, etc.
(B) Remove, ignore or fix the data 112 identified explicitly because of integration issues:
The data 112 identified above because of integration issues can simply be removed or ignored if the content is not relevant.
If the data 112 identified above because of integration issues has content that is relevant, then the process of integration should be reviewed.
(C) Custom machine learning models 110 can be created for new, unexpected or problem patterns in the data 112 that are client-specific:
Custom machine learning models 110 for new, unexpected or problem patterns of writing headers, list items, paragraph openings, surgery reports, etc., can be added to an existing stack of machine learning models 110 used in the natural language processing.
The unsupervised machine learning models 110 may calculate quality as: quality=ax+by+cz, and the custom machine learning models 110 may calculate quality as: quality'=a'x+b'y+c'z.

Block 206 represents the cognitive computing services 104 retraining the machine learning models 110, including both the unsupervised machine learning models 110 and the custom machine learning models 110, using the data 112, which should result in an increase in the overall quality score. Moreover, this block includes the cognitive computing services 104 using the unsupervised machine learning models 110 and/or the custom machine learning models 110 to analyze additional data 112, namely, a subsequent set of data 112.

Block 208 represents the cognitive computing services 104 generating a report that may include the following:
(A) The data 112.
(B) The existing quality heuristics.
(C) The new, unexpected or problem patterns.
(D) The clusters.
(E) The sources of the patterns.
(F) The data 112 that was identified as having a quality score below a threshold in the unsupervised machine learning model 110, and is now identified as having a quality score at or above the threshold in the custom machine learning model 110, which has many uses including showing where additional natural language processing efforts should be focused.
(G) The new quality heuristics and the resulting client-specific document quality model.
(H) The overall natural language processing readiness of this client.
(I) The machine learning models 110.

Benefits and Advantages

Some of the benefits and advantages of the present invention is that it proactively detects issues before results are delivered to the client. Also, instead of fixing a single issue at a time, the present invention can holistically identify new, unexpected or problem patterns in a client's data 112 and architect an approach to handle all of the potential issues resulting therefrom in advance. This also opens a line of communication with clients to better understand their data 112 and the patterns therein that need to be addressed.

For example, it may be determined that the new client's data 112 has documents with shorter sentences and worse parse trees than average, but that these documents are still acceptable for the natural language processing. In another example, it may be determined that the new client's data 112 has a set of documents that are unusable for the natural language processing. Generally, most issues will lie somewhere between these extremes.

Cloud Computing

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

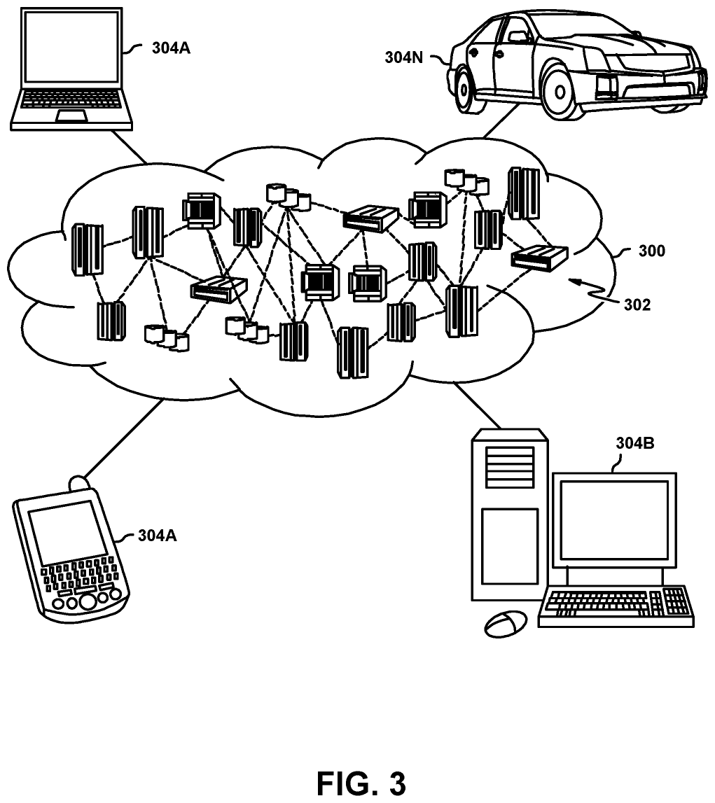

Referring now to FIG. 3, an illustrative cloud computing environment 300 is depicted. As shown, cloud computing environment 300 includes one or more cloud computing nodes 302 with which local computing devices used by cloud consumers, such as, for example, personal digital assistant (PDA) or cellular telephone 304A, desktop computer 304B, laptop computer 304C, and/or automobile computer system 304N may communicate. Nodes 302 may communicate with one another. They may be grouped (not shown) physically or virtually, in one or more networks, such as Private, Community, Public, or Hybrid clouds as described hereinabove, or a combination thereof. This allows cloud computing environment 10 to offer infrastructure, platforms and/or software as services for which a cloud consumer does not need to maintain resources on a local computing device. It is understood that the types of computing devices 304A-N shown in FIG. 3 are intended to be illustrative only and that computing nodes 302 and cloud computing environment 300 can communicate with any type of computerized device over any type of network and/or network addressable connection (e.g., using a web browser).

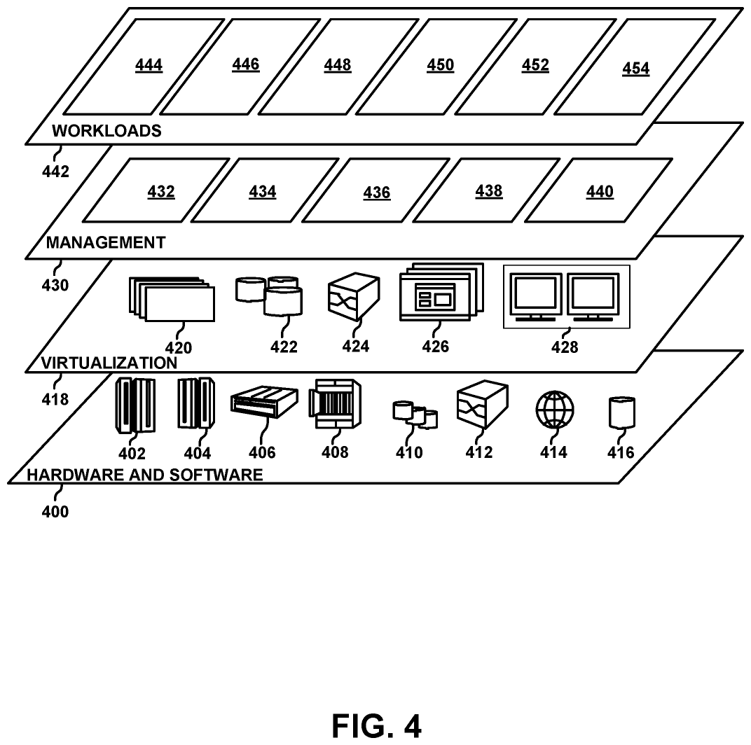

Referring now to FIG. 4, a set of functional abstraction layers provided by a cloud computing environment is shown. It should be understood in advance that the components, layers, and functions shown in FIG. 4 are intended to be illustrative only and embodiments of the invention are not limited thereto. As depicted, the following layers and corresponding functions are provided:

Hardware and software layer 400 includes hardware and software components. Examples of hardware components include: one or more computers such as mainframes 402, RISC (Reduced Instruction Set Computer) architecture based servers 404, servers 406, and blade servers 408; storage devices 410; and networks and networking components 412. In some embodiments, software components include network application server software 414 and database software 416.

Virtualization layer 418 provides an abstraction layer from which the following examples of virtual entities may be provided: virtual servers 420; virtual storage 422; virtual networks 424, including virtual private networks; virtual applications and operating systems 426; and virtual clients 428.

In one example, management layer 430 may provide the functions described below. Resource provisioning 432 provides dynamic procurement of computing resources and other resources that are utilized to perform tasks within the cloud computing environment. Metering and pricing 434 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 436 provides access to the cloud computing environment for consumers and system administrators. Service level management 438, which includes containers, provides cloud computing resource allocation and management such that required service levels are met. Service Level Agreement (SLA) planning and fulfillment 440 provide pre-arrangement for, and procurement of, cloud computing resources for which a future requirement is anticipated in accordance with an SLA.

Workloads layer 442 provides examples of functionality for which the cloud computing environment may be utilized. Examples of workloads, tasks and functions which may be provided from this layer include: mapping and navigation 444; software development and lifecycle management 446; virtual classroom education delivery 448; data analytics processing 450; transaction processing 452; generating a client-specific document quality model 454, etc.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Conclusion

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating, in one or more computers, a client-specific document quality model, by:
analyzing data using existing quality heuristics to identify new, unexpected or problem patterns in the data;
forming the quality heuristics into one or more clusters for each container level of the data;
exploring each of the clusters to identify sources of the patterns; and
developing new quality heuristics based on the sources of the patterns, wherein the new quality heuristics are used to generate the client-specific document quality model.

2. The method of claim 1, wherein the data is comprised of documents or text.

3. The method of claim 1, wherein the container level comprises document, section, paragraph or sentence.

4. The method of claim 1, wherein forming the quality heuristics into clusters comprises using unsupervised machine learning models to cluster the quality heuristics.

5. The method of claim 1, further comprising retrieving and reviewing the data corresponding to the clusters to ratify a comparison of quality scores with a threshold.

6. The method of claim 1, wherein the patterns comprise an issue of integration or an issue that is client-specific.

7. The method of claim 1, wherein the existing and new quality heuristics are used to analyze additional data.

8. The method of claim 1, further comprising generating a report describing: the existing quality heuristics, the new, unexpected or problem patterns; the clusters; the sources of the patterns; the new quality heuristics; and the client-specific document quality model.

9. A computer-implemented system, comprising:
one or more computers programmed to generate a client-specific document quality model, by:
analyzing data using existing quality heuristics to identify new, unexpected or problem patterns in the data;
forming the quality heuristics into one or more clusters for each container level of the data;
exploring each of the clusters to identify sources of the patterns; and
developing new quality heuristics based on the sources of the patterns, wherein the new quality heuristics are used to generate the client-specific document quality model.

10. The system of claim 9, wherein the data is comprised of documents or text.

11. The system of claim 9, wherein the container level comprises document, section, paragraph or sentence.

12. The system of claim 9, wherein forming the quality heuristics into clusters comprises using unsupervised machine learning models to cluster the quality heuristics.

13. The system of claim 9, further comprising retrieving and reviewing the data corresponding to the clusters to ratify a comparison of quality scores with a threshold.

14. The system of claim 9, wherein the patterns comprise an issue of integration or an issue that is client-specific.

15. The system of claim 9, wherein the existing and new quality heuristics are used to analyze additional data.

16. The system of claim 9, further comprising generating a report describing: the existing quality heuristics, the new, unexpected or problem patterns; the clusters; the sources of the patterns; the new quality heuristics; and the client-specific document quality model.

17. A computer program product, the computer program product comprising a computer readable storage medium having program instructions embodied therewith, the program instructions executable by one or more computers to cause the computers to perform a method comprising:
generating a client-specific document quality model, by:
analyzing data using existing quality heuristics to identify new, unexpected or problem patterns in the data;
forming the quality heuristics into one or more clusters for each container level of the data;
exploring each of the clusters to identify sources of the patterns; and
developing new quality heuristics based on the sources of the patterns, wherein the new quality heuristics are used to generate the client-specific document quality model.

18. The computer program product of claim 17, wherein forming the quality heuristics into clusters comprises using unsupervised machine learning models to cluster the quality heuristics.

19. The computer program product of claim 17, further comprising retrieving and reviewing the data corresponding to the clusters to ratify a comparison of quality scores with a threshold.

20. The computer program product of claim 17, wherein the patterns comprise an issue of integration or an issue that is client-specific.
